(19) United States
(12) Patent Application Publication
(10) Pub. No.: US 2010/0244736 A1
(43) Pub. Date: Sep. 30, 2010

(54) LIGHTING SYSTEM AND LIGHTING ASSEMBLY

(75) Inventors: Colin BAXTER, Healesville VIC (AU); Kingsley McRAE, Oakleigh East VIC (AU)

Correspondence Address: DAVIS & BUJOLD, P.L.L.C., 112 PLEASANT STREET, CONCORD, NH, 03301, US

(73) Assignee: FARADAY PTY LTD SHIELDING & DESIGN, Bayswater VIC (AU)

(21) Appl. No.: 12/748,568

(22) Filed: Mar. 29, 2010

Related U.S. Application Data
(60) Provisional application No. 61/165,364, filed on Mar. 31, 2009.

(51) Int. Cl. H05B 37/02

(52) U.S. Cl. 315/294

(57) ABSTRACT

The present invention provides a lighting system adapted to provide lighting for an electromagnetic interference (EMI) shielded environment. The lighting system comprises a plurality of lighting fixtures each adapted to receive a light emitting diode (LED) light source, and a plurality of current limiting circuits each adapted to limit electrical current provided to power one or more of the LED light sources. The electrical current is provided from a direct current source external to the EMI shielded environment and filtered to minimise electromagnetic interference introduced into the EMI shielded environment.

### FIELD OF THE INVENTION

The field of the invention is lighting systems and lighting assemblies for use low electromagnetic interference (EMI) environments. An example of an application of the lighting system and lighting assembly of the present invention is for lighting in a magnetic resonance imaging (MRI) room.

### BACKGROUND OF THE INVENTION

An environment having very low electromagnetic interference is required for effective operation of some electronic equipment. Such equipment is typically operated in a room or other environment provided with electromagnetic interference shielding against external EMI. Such a shielded environment is often referred to as a Faraday cage. The shielding of the cage is adapted to dramatically attenuate the electromagnetic field to minimise EMI in the cage interior. However, equipment operating within the cage can generate EMI to interfere with the operation of other equipment within the cage. It is known to impose strict requirements on EMI leakage from equipment to be used within an EMI shielded environment.

Magnetic resonance imaging (MRI) is a specific example of equipment which requires a low EMI environment. Radio frequency (RF) interference with an MRI receiver is a known cause of image quality degradation. To minimise RF interference MRI equipment is typically installed in a shielded room. However, interference can be introduced into the EMI shielded environment via equipment used within the room, including room lighting. It is therefore necessary to provide low interference lighting in such as environment.

A further problem is that MRI technology utilises strong magnetic fields. The strong magnetic fields can affect any ferrous or magnetically reactive components of light sources, for example reducing the working life of an incandescent bulb type light source. Further, ferrous or magnetically reactive components of any equipment within the MRI room may also affect the magnetic field of the MRI equipment and hence degrade the quality of the image.

There is a need for alternative types of lighting systems and assemblies suitable for use in MRI rooms and other shielded environments.

### SUMMARY OF THE INVENTION

According to one aspect of the present invention there is provided a lighting system adapted to provide lighting for an electromagnetic interference (EMI) shielded environment, the lighting system comprising:

a plurality of lighting fixtures each adapted to receive one or more light emitting diode (LED) light sources; and

a plurality of current limiting circuits each adapted to limit electrical current provided to power one or more of the LED light sources, wherein the electrical current is provided from a direct current source external to the EMI shielded environment and filtered to minimise electromagnetic interference introduced into the EMI shielded environment.

In some embodiments the lighting fixtures, light sources, and current limiting circuits are all constructed from substantially non-ferrous or non-magnetic materials to be compatible with a magnetic resonance imaging environment.

In some embodiments each LED light source is a LED lamp comprising one or more LEDs. For example, each lamp may include up to five LEDs. For example, the LED lamps can have an MR16 type configuration and the fixtures can be compatible down-light style fixtures.

In some embodiments a current limiting circuit is provided for each light source.

Each current limiting circuit can include a diode bridge to make the circuit polarity independent.

Embodiments of the lighting system can further comprise: a power supply for installation external to the shielded environment and adapted to supply DC current; and a filter adapted to filter noise from the DC current before supplying the DC current into the shielded environment.

The DC current source can include an alternating current to direct current (AC/DC) converter.

According to another aspect there is provided a lighting assembly adapted for use in an electromagnetic interference sensitive environment, the lighting assembly comprising: a light fixture adapted to receive one or more light emitting diode (LED) light sources; and one or more current limiting circuits adapted to limit electrical current provided from a direct current source to power the LED light sources.

In an embodiment the fixture is adapted to receive one LED light source and the lighting assembly has one current limiting circuit.

In an alternative embodiment the fixture is adapted to receive more than one LED light source and the lighting fixture has one current limiting circuit.

The lighting fixture, light source, and current limiting circuit can be constructed from substantially non-ferrous or non-magnetic materials to be compatible with a magnetic resonance imaging environment.

### BRIEF DESCRIPTION OF THE DRAWINGS

An embodiment, incorporating all aspects of the invention, will now be described by way of example only with reference to the accompanying drawings in which:

FIG. 1 illustrates an example of a lighting system;

FIG. 2 illustrates a representative circuit diagram for use with a light source in an embodiment of the system;

FIGS. 3a and 3b illustrate representative circuit diagrams for use in alternative embodiments of the system;

FIG. 4 illustrates an embodiment of a lighting system; and

FIG. 5 illustrates an example of a light source.

### DETAILED DESCRIPTION OF THE PREFERRED EMBODIMENTS

A lighting system adapted for use in an electromagnetic interference (EMI) shielded environment is provided. The lighting system comprises a plurality of lighting fixtures each adapted to receive one or more light emitting diode (LED) light sources, and a plurality of current limiting circuits. The current limiting circuits are adapted to limit electrical current provided to power one or more of the LED light sources. Electrical current can be supplied from a direct current source external to the EMI shielded environment and filtered to minimise electromagnetic interference introduced into the EMI shielded environment.

The current limiting circuits, lighting fixtures, and LED light sources used in the lighting assemblies are adapted for installation within the EMI shielded environment. In particular the circuits and LED light sources are designed to generate no or minimal EMI when operating. Further, constructing the components of substantially non-ferrous materials provide embodiments of the system particularly well suited for use in MRI rooms.

Strict constraints are imposed on lighting systems for use in MRI rooms. For example, a lighting system for an MRI room must exhibit low electromagnetic noise at the operating frequency range of the MRI equipment. The operating frequency of MRI equipment is determined by the magnetic field, as shown in the example in Table 1. However, MRI equipment can be manufactured to operate over a broad range of frequencies within the radio frequency range. The operating frequency can vary depending on the application the MRI equipment is designed for. For example, magnets from 0.2 Tesla to 3.0 Tesla are currently used in MRI equipment designed for use on people.

TABLE 1

| Magnet Strength (Tesla) | Nominal Operating Frequency (MHz) |
|---|---|
| 1 T | 42.6 MHz |
| 1.5 T | 63.9 MHz |
| 3.0 T | 127.8 MHz |

Embodiments of the lighting system can be adapted to minimise electromagnetic interference in the radio frequency range, 3 KHz to 3 GHz. In some embodiments the focus for minimising electromagnetic interference may be around the operating frequency for the equipment in the shielded environment.

Two aspects of the lighting system are utilised to reduce electromagnetic interference. First, filtering of the input DC power supply is used to attenuate noise around the operating frequency range. This minimises the noise introduced into the EMI shielded environment. Second, DC powered LED light sources are used as these independently generate little or no EMI. Further, elements for supporting circuitry can be chosen to minimise generation of EMI within the shielded environment.

Noise from the lighting system at the operating frequency of the MRI system must be minimised to avoid interference with the MRI receiver and consequent image quality degradation. For example some MRI equipment manufacturers specify 100 db down on 100 millivolts per metre as the noise limit. Typically this means the lighting system should exhibit no more noise at the operating frequency than a standard incandescent light bulb. Although incandescent lights may comply with the noise constraints for an MRI environment, the magnetic field can act on components of an incandescent light bulb, in particular the filament, to significantly shorten the useful life of the bulb. This can present efficiency problems due to operational time of the MRI equipment being reduced or limited due to the maintenance requirements of the lighting system. Further, where the MRI is being used in a medical operating theatre loss of lighting, due to a light bulb failing, may compromise the safety of the operating theatre and hence put the patient at risk.

Due to the strong magnetic fields of MRI equipment, non-ferrous or substantially non-ferrous lighting equipment is recommended for the MRI room. Use of non-ferrous or substantially non ferrous lighting equipment also minimises risk of disturbance of the magnetic field due to the lighting equipment and consequent image quality problems.

The requirement for low noise and non-ferrous or substantially non-ferrous lighting equipment precludes most commonly used light sources from use in MRI rooms. For example, fluorescent lights, compact fluorescent lights, low voltage down lights with transformers, etc cannot be used around MRI equipment. Commercially available LED lighting systems are also unsuitable as active power supply control circuitry located with the LED bulbs is typically non-ferrous and also creates unacceptable levels of noise.

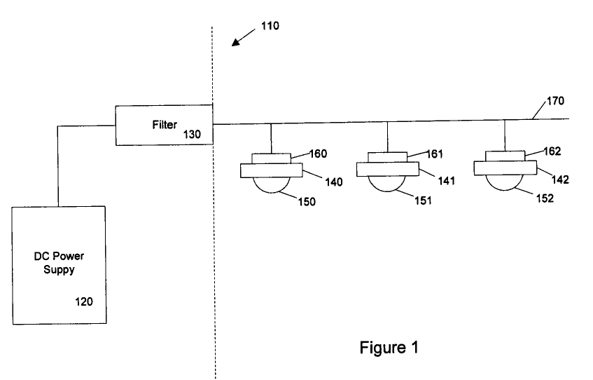

Embodiments disclosed herein provide a lighting system enabling LED light sources to be used within a shielded environment. An example of a lighting system is illustrated in FIG. 1. The lighting system of FIG. 1 comprises a plurality of lighting fixtures 140-142 each adapted to receive an LED light source 150-152, and a plurality of current limiting circuits 160-162. The current limiting circuits are adapted to limit electrical current provided to power one or more of the LED light sources. Electrical current is supplied from a direct current source 120 external to the EMI shielded environment 110 and filtered 130 to minimise any radio frequency interference introduced into the EMI shielded environment 110. The lighting fixtures, light sources, and current limiting circuits can all be constructed from non ferrous, substantially non-ferrous and non-magnetic materials to be compatible with an MRI environment.

Each LED light source 150 is an LED lamp comprising one or more LEDs. Heat generated by LEDs during operation can be significant where a large number of LEDs are used in a single bulb, requiring heat sinks or other heat dissipation techniques to be employed to prevent the LEDs exceeding maximum operating temperature thresholds. If the maximum operating temperature for the LEDs is exceeded this can cause failure of the LEDs or damage to surrounding fixtures and other components of the lighting assembly due to excessive heat.

Advantageous embodiments of the lighting system described herein use light sources having only a small number of LEDs to avoid the above described heat dissipation problems. For example, LED lamps or bulbs having one to five LEDs can be used, for example, an LED lamp comprising three LEDs. The lamps may comprise a reflector adapted to reflect the light generated by the LEDS into a targeted beam. For example, a multifaceted reflector (MR) type reflector. Reflectors may be non-metallic dichroic reflectors or aluminium. For example the reflector may comprise a pressed glass, plastic or resin shell with the facets shaped in the inside surface and covered with aluminium or dichroic reflective coating. A dichroic reflector has a multilayer non-metallic film coating which reflects visible light but can allow infrared radiation to pass through, which can have heat dissipation advantages over aluminium reflectors which reflect the full spectrum of radiation emitted by the LEDs. An example of a suitable commercially available lamp is an MR16 type LED lamp. However, other types of LED lamps may be used.

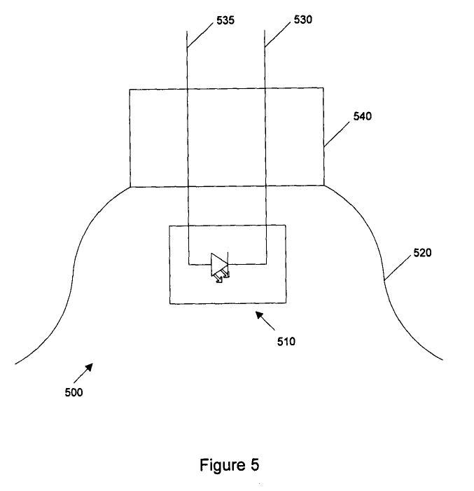

Illustrated in FIG. 5 is an example of an LED lamp 500 having one or more LEDs 510 electrically connected to leads 530, 535 and a reflector 520. In the illustrated example the two connector leads 530, 535 extend through a connector housing 540 attached to the reflector. The connector housing is shaped to cooperate with a socket for establishing an electrical connection to a power supply. For example, a light fixture socket connected to electrical power supply wiring. The housing may also be shaped to cause the lamp to be retained in the socket, for example using interference fit or friction. In embodiments where current limiting circuit components are provided on the light source, the current limiting circuit components may also be housed within the housing, for example a resistor embedded within the housing and electrically connected in series with the LEDs. Alternatively current limiting circuit components may be provided on a small circuit board adapted to be connected to the lamp or fixture socket in a manner which forms an appropriate electrical connection with the LEDs 510 via the connectors 530, 535.

The light fixtures and respective sources can be arranged in a down-light array style configuration with a sufficient number of light sources to provide the illumination levels required in the environment. Using a down-light array style configuration provides space between the light sources to allow heat dissipation and minimise heat accumulation between light sources, and hence alleviate the need for heat sinks, fans or other heat dissipation techniques.

For an MRI room non-ferrous or substantially non-ferrous lighting assemblies are used in order to minimise any interference with the magnetic field caused by the lighting system. The lighting fixtures may be specifically designed for the MRI environment or commercially available fixtures which are non-ferrous or substantially non-ferrous and therefore suitable for use in an MRI environment. The number of light sources and arrangement of the lighting assemblies is chosen to meet the illumination requirements of the MRI room.

Having a lighting system which uses a plurality of LED light sources having a small number of LEDs enables the lighting layout to be flexibly designed for each installation. Lighting assemblies can be small footprint, single lamp fixtures, multiple lamp fixtures or a combination thereof. For example, use of a plurality of single lamps enables the light sources to be clustered with greater density in areas where more intense illumination is required and in lower density in other areas where less intense illumination is required.

A further advantage is that embodiments of the system can be designed to utilise commercially mass produced LED light sources. It should be appreciated that although the LED light sources for commercially available lighting systems may be suitable for use in an EMI shielded environment such as an MRI room the commercially available lighting systems are unsuitable. Commercially available LED lighting systems use transformers and/or active circuit components which would introduce unacceptable interference into the shielded environment.

Some commercially available LED light sources are substantially non-ferrous and therefore suitable for use in MRI applications. Commercially available LED light sources are used in variety of domestic and commercial lighting systems, with such a broad market, the LED light sources are typically low cost and easily available. This can significantly reduce the cost of the system both for initial installation and ongoing maintenance, for example, compared with known MRI lighting systems which use proprietary light sources and fittings designed specifically for MRI applications and available for purchase and installation only through a limited number of suppliers. For example, the light sources may be “off the shelf” readily available LED lamps which can be easily replaced by a handyman, rather than requiring a specialist technician for replacing a failed lamp after the initial installation.

The power supply for the lighting system is provided by a DC power supply 120 external to the EMI shielded environment. This alleviates the need to construct a power supply or transformer to comply with the low EMI noise requirements to drive the LED light sources from within the shielded environment. The direct current can be supplied to the lighting system using a direct current source, such as a DC generator or battery, or using a standard alternating current to direct current (AC/DC) converter power supply module. The DC supply is filtered using a filter module 130 to attenuate any noise from the power supply before the current is supplied into the shielded environment. For example the filter module 130 may be designed for an MRI application to filter RF noise around the operating frequency of the MRI system.

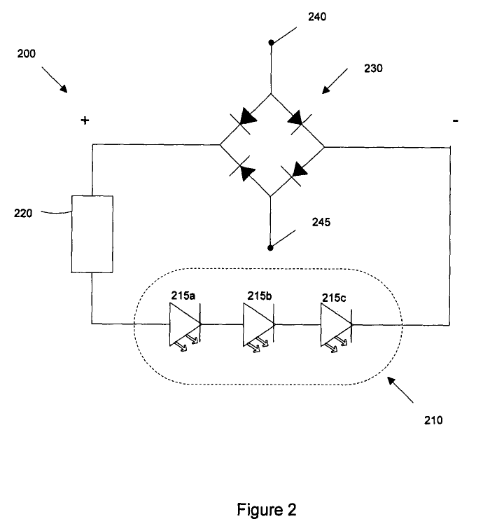

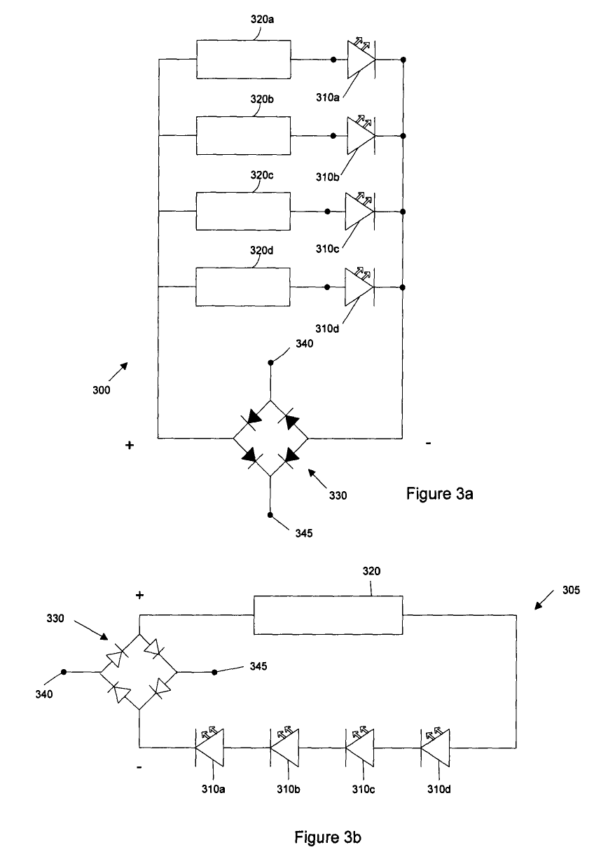

A plurality of current limiting circuits are provided to enable constant current to be provided to each LED light source. The current limiting circuits can form a current limiting network which drives all the LED light sources at the same current level in order to achieve uniform luminosity. A current limiting circuit may be provided for each LED light source in one to one relationship or a current limiting circuit may be provided for two or more light sources, the configuration may vary depending on the embodiment. Each current limiting circuit can include a diode bridge to make the circuit polarity independent. Examples of some current limiting circuit configurations are illustrated in FIGS. 2, 3a and 3b. FIG. 2 illustrates a representative circuit diagram for a lighting assembly having a current limiting circuit in one to one relationship with an LED light source. For example, the circuit 200 can be representative of an embodiment where the LED light source and current limiting circuit are integrated into a single package. For example, this package may be an embodiment of an LED lamp provided with a current limiting circuit adapted to plug into a lighting fixture for connection to a power supply. The current limiting circuit may be provided on a printed circuit board which may be connected to or connectable to the light source. In some embodiments, the diode bridge can also be included on the printed circuit board. An advantage of including the current limiting circuit and diode bridge on a printed circuit board is ease of handling. A further advantage can be improved heat dissipation and thermal properties of the current limiting circuit and diode bridge, enabled through use of the printed circuit board. Alternatively the lighting assembly may comprise a lighting fixture with an embedded current limiting circuit and LED, adapted to connect to a power supply. In an embodiment only passive elements are used in the current limiting circuit to reduce the risk of generation of unacceptable noise from the lighting system.

The circuit 200 comprises an LED light source 210, current limiting circuit components 220, a diode bridge 230 and connectors 240, 245 for connection to the external DC power supply. The LED light source 210 of this embodiment comprises three individual LEDs 215a-c. Typically the LEDs are housed in a reflective housing (not shown). The diode bridge 230 is optional. Having, the diode bridge 230 means the circuit can be installed without worrying about the polarity of the power supply connected across the connectors 240, 245. In an embodiment where the diode bridge 230 is omitted a polarity requirement is imposed for connecting the circuit to the DC power supply. It should be appreciated that a plurality of these circuits can be connected in parallel to a DC power supply.

FIGS. 3a and 3b illustrate two alternative examples of circuits for lighting assemblies including a plurality of LED light sources 310a-d, for example these circuits could be embedded in a single lighting fixture adapted to receive a plurality of LED lamps 310a-d. Each LED lamp 310a-d may comprise more than one LED. The embodiment of FIG. 3a illustrates an example of a circuit 300 where the LED light sources 310a-d connected in parallel. Current limiting circuit components 320a-d are provided to control the current through each LED light source and optionally a bridge 330 is avoid having to define the polarity of the connector leads 340 345 for connection to a DC power supply.

The embodiment of FIG. 3b illustrates an example of a circuit 305 for a lighting assembly where a plurality of LED light sources 310a-d are connected in series. Current limiting circuit components 320 are provided to control the current through the LED light sources 310a-d. Optionally a bridge 330 is provided to avoid having to define the polarity of the connector leads 340 345 for connection to a DC power supply.

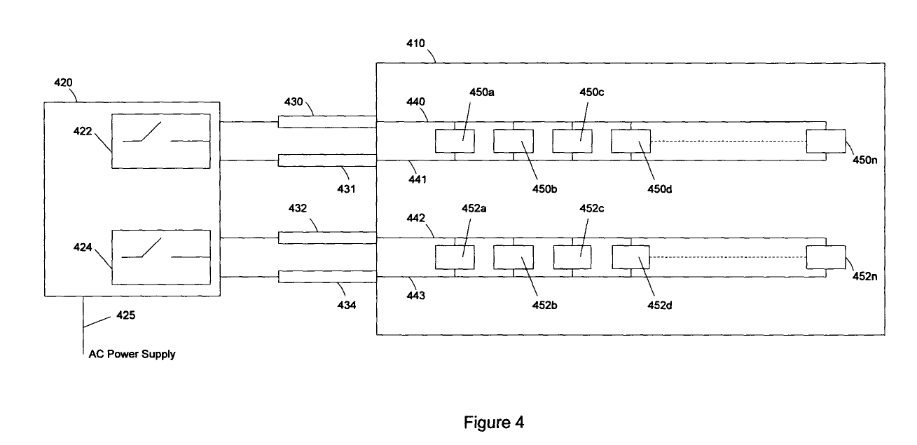

FIG. 4 illustrates an example of a lighting system for use in an MRI room. The lighting system for installation within the shielded MRI room 410 includes a plurality of lighting assemblies 450a-n and 452a-n, in this embodiment each lighting assembly comprises a fixture adapted to contain an LED light source and current limiting circuit as illustrated in FIG. 2. In the illustrated two sets of DC power supply wires 440, 441 and 442, 443 are provided. The circuits and light sources of lighting assemblies 450a-n are connected in parallel across the first set of DC power supply wires 440 and 441. The circuits and light sources of lighting assemblies 452a-n are connected in parallel across the second set of DC power supply wires 442 and 443. It should be understood that although two sets of power supply wires are illustrated in FIG. 4 this number of sets of power supply wires may be varied depending on the embodiment and the lighting design for the room. All possible variations are envisaged within the scope of the present application.

DC power is supplied via an AC/DC power supply 420 from a mains AC power supply. The AC/DC power supply includes all the electrical components required to convert the mains AC power supply to a DC power supply suitable to power the lighting system. For example, converting mains 240 volts 50 Hz alternating current supply to a 12 volt direct current supply. The power supply 420 may be provided with a plurality of DC power connections and switches 422, 424 may be provided to enable DC power to be selectively provided to each set of connections, for example to enable lights connected via each set of power supply lines to be turned on and off selectively. In an alternative embodiment DC power output from the AC/DC power supply may be input to a switch box which includes circuitry and switches to provide multiple power outputs which can be selectively turned ON or OFF.

Filters 430-434 are provided to filter interference from the DC power supply. In the embodiment shown a filter is provided for each DC power supply wire. The filters can be adapted to attenuate out any RF interference at and around the operating frequency of the MRI equipment in the room.

An advantage of locating the power supply outside the shielded environment and filtering potential interference from the power supply before the power is injected into the shielded environment to power the lighting system, is that strict requirements imposed on equipment used within a shielded environment need not be complied with for the power supply, provided the filtering is sufficient for the power supplied into the shielded environment to comply with imposed low noise requirements. This can represent a significant reduction in cost, for example by enabling an “off the shelf” power supply to be used. Ability to use “off the shelf” or readily available equipment in the lighting system can also alleviate potential problems regarding the availability of components for the original supply and ongoing maintenance of the system.

In some embodiments a dimmer may be provided at the power supply operable to alter the output current and cause a corresponding change in luminosity. Alternatively and/or additionally control may be provided to enable some LED light sources to be selectively turned on or off to change the illumination level in the room or in regions of the room. Whether light sources can be selectively turned off and any regions can be defined when designing the lighting layout for the installation.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A lighting system adapted to provide lighting for an electromagnetic interference (EMI) shielded environment, the lighting system comprising:
a plurality of lighting fixtures each adapted to receive a light emitting diode (LED) light source; and
a plurality of current limiting circuits each adapted to limit electrical current provided to power one or more of the LED light sources, wherein the electrical current is provided from a direct current source external to the EMI shielded environment and filtered to minimise electromagnetic interference introduced into the EMI shielded environment.

2. A lighting system as claimed in claim 1 wherein the lighting fixtures, light sources, and current limiting circuits are all constructed from substantially non-ferrous or non-magnetic materials to be compatible with a magnetic resonance imaging environment.

3. A lighting system as claimed in claim 2 wherein each LED light source is a LED lamp comprising one or more LEDs.

4. A lighting system as claimed in claim 3 wherein each lamp includes up to five LEDs.

5. A lighting system as claimed in claim 4 the LED lamps have an MR16 type configuration and the fixtures are compatible down-light style fixtures.

6. A lighting system as claimed in claim 2 wherein a current limiting circuit is provided for each light source.

7. A lighting system as claimed in claim 6 wherein each current limiting circuit includes a diode bridge to make the circuit polarity independent.

8. A lighting system as claimed in claim 2 further comprising:
a power supply for installation external to the shielded environment and adapted to supply DC current; and
a filter adapted to filter noise from the DC current before supplying the DC current into the shielded environment.

9. A lighting system as claimed in claim 8 wherein the DC current source includes an alternating current to direct current (AC/DC) converter.

10. A lighting assembly adapted for use in an electromagnetic interference sensitive environment, the lighting assembly comprising:
a fixture adapted to receive one or more light emitting diode (LED) light sources; and
one or more current limiting circuits adapted to limit electrical current provided from a direct current source to power the LED light sources.

11. A lighting assembly as claimed in claim 10 wherein the lighting fixture, light sources, and current limiting circuits are all constructed from substantially non-ferrous or non-magnetic materials to be compatible with a magnetic resonance imaging environment.

12. A lighting assembly as claimed in claim 11 wherein the LED light sources are LED lamps including up to 5 LEDs.

13. A lighting assembly as claimed in claim 12 wherein each LED lamp has an MR16 type configuration and the fixture is a compatible down-light style fixture.

14. A lighting assembly as claimed in claim 10 wherein the fixture is adapted to receive one LED light source and having one current limiting circuit.

15. A lighting assembly as claimed in claim 10 wherein the fixture is adapted to receive more than one LED light source and having one current limiting circuit.
